(19) United States
(12) Patent Application Publication
(10) Pub. No.: US 2022/0387834 A1
(43) Pub. Date: Dec. 8, 2022

(54) FIRE SUPPRESSION SYSTEM INCLUDING NOZZLE WITH MULTIPLE SPRAY ANGLES

(71) Applicant: Tyco Fire Products LP, Lansdale, PA (US)

(72) Inventor: Chad L. Ryczek, Oconto Falls, WI (US)

(73) Assignee: Tyco Fire Products LP, Lansdale, PA (US)

(21) Appl. No.: 17/774,470

(22) PCT Filed: Dec. 3, 2020
(86) PCT No.: PCT/IB2020/061453

§ 371 Date: May 4, 2022

Related U.S. Application Data
(60) Provisional application No. 62/944,219, filed on Dec. 5, 2019.

(51) Int. Cl. A62C 35/68; B05B 12/16

(52) U.S. Cl. CPC A62C 35/68; B05B 12/16

(57) ABSTRACT

A method for suppressing a fire including providing a fire suppression system including at least one nozzle within a hazard area, activating the fire suppression system in response to detecting a potential fire within the hazard area, and releasing a fire suppression agent toward the hazard area through the at least one nozzle at a spray angle defined between outermost edges of fire suppression agent when released through the at least one nozzle. The spray angle is a first spray angle for a first time period. The method further including releasing the fire suppression agent toward the hazard area through the at least one nozzle at a second spray angle, greater than the first spray angle, for a second time period.

### CROSS-REFERENCE TO RELATED PATENT APPLICATION

This application claims the benefit of and priority to U.S. Patent Application No. 62/944,219, filed Dec. 5, 2019, the entire disclosure of which is hereby incorporated by reference herein.

### BACKGROUND

Fire suppression systems are commonly used to protect an area and objects within the area from fire. Fire suppression systems can be activated manually or automatically in response to an indication that a fire is present nearby (e.g., an increase in ambient temperature beyond a predetermined threshold value, etc.). Once activated, fire suppression systems spread a fire suppression agent throughout the area. The fire suppression agent then extinguishes or prevents the growth of the fire.

### SUMMARY

One embodiment of the present disclosure relates to a method for suppressing a fire. The method for suppressing a fire including providing a fire suppression system including at least one nozzle within a hazard area, activating the fire suppression system in response to detecting a potential fire within the hazard area, and releasing a fire suppression agent toward the hazard area through the at least one nozzle at a spray angle defined between outermost edges of fire suppression agent when released through the at least one nozzle. The spray angle is a first spray angle for a first time period. The method further including releasing the fire suppression agent toward the hazard area through the at least one nozzle at a second spray angle, greater than the first spray angle, for a second time period.

Another embodiment of the present disclosure relates to a fire suppression system. The fire suppression system including an agent tank configured to store a quantity of a fire suppression agent, a nozzle configured to release at least a portion of the quantity of the fire suppression agent, and a conduit coupling the agent tank to the nozzle to direct the fire suppression agent from the agent tank to the nozzle. The fire suppression agent is released through the nozzle in a conical pattern. The fire suppression system also includes a spray angle defined between two edges of the conical pattern. The spray angle is a first spray angle for a first time period and a second spray angle for a second time period.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is an illustration of a fire suppression system, according to one embodiment.

FIG. 2 is an illustration of various components of the fire suppression system of FIG. 1, according to one embodiment.

FIG. 3 is an illustration a delivery system for use in the fire suppression system of FIG. 1, according to one embodiment.

FIG. 4 is an illustration a delivery system for use in the fire suppression system of FIG. 1, according to another embodiment.

FIG. 5 is an illustration a delivery system for use in the fire suppression system of FIG. 1, according to another embodiment.

FIG. 6 is an illustration a delivery system for use in the fire suppression system of FIG. 1, according to another embodiment.

FIG. 7 is an illustration of a pair of nozzles for use in the fire suppression system of FIG. 1, according to one embodiment.

FIG. 8 is an illustration of a pair of nozzles for use in the fire suppression system of FIG. 1, according to another embodiment.

FIG. 9 is an illustration of a nozzle for use in the fire suppression system of FIG. 1, according to one embodiment.

FIG. 10 is a table depicting results of a cooling test of a fire suppression system, according to one embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Hazard areas (e.g., kitchens, vehicles, etc.) often contain flammable materials (e.g., grease, oil, cloth, hydraulic fluid, etc.) in close proximity to hazards, such as engines with superheated components (e.g., combustion chamber, etc.), or cooking appliances that include heat sources (e.g., ovens, stoves, fryers, etc.). Because of this, hazard areas often experience fires, especially in an engine bay or near cooking appliances. Hazard areas may be outfitted with fire suppression systems to combat such fires. These fire suppression systems generally include nozzles that are configured to release a fire suppression agent (e.g., water, foam, powder, etc.) toward a hazard in response to detection of a fire. Detection components (e.g., thermal detectors, optical detectors, etc.) are located in or near the hazard areas to determine if a fire has ignited.

If a fire has ignited within the hazard areas, the nozzles release the fire suppression agent throughout the hazard area. Generally, the nozzles release the fire suppression in a conical pattern and at a first angle of spray to form a crust over a surface of the hazard area. The crust substantially limits a fire from reigniting by reducing the supply of oxygen. In some applications of the fire suppression system (e.g., in kitchens, etc.), the hazard area can reach temperatures high enough to reignite after the crust has formed. In such applications, a second release or continued release of fire suppression agent can be configured to cool the hazard area. The second release of fire suppression agent can be through the same nozzles as the original release of fire suppression agent, or the second release can occur through a second set of nozzles. Further, the second set of nozzles can release the fire suppression agent at an angle different than an angle of release of the first nozzles. Different angles of release of the fire suppression agent can have different benefits within the hazard area. A smaller angle may suppress a fire quicker than a larger angle. A larger angle may facilitate continued cooling within the hazard area.

Referring generally to the figures, fire suppression systems are configured for use in a hazard area (e.g., a kitchen, an engine area, etc.). Fire suppression systems include components configured to suppress a fire within the hazard area. One or more nozzles are configured to release a fire suppression agent on a heated element (e.g., a combustion chamber, a supercharger, a fryer, a stovetop, etc.). The nozzles are fluidly coupled to an agent tank or reservoir via a conduit (e.g., distribution piping). The tank or reservoir is configured to store a quantity of fire suppression agent. A release assembly is coupled to the agent tank to facilitate the release of fire suppression agent from the agent tank via an actuator and a cartridge of expellant gas. The actuator is configured to facilitate the release of the expellant gas from the cartridge into the agent tank.

The fire suppression system can include a valve configured to switch the flow of fire suppression agent from a first agent tank to a second agent tank. The first agent tank may be pressurized at a first pressure to facilitate a first flow rate of the fire suppression agent through the conduit (e.g., distribution piping) and the second agent tank may be pressurized at a second pressure to facilitate a second flow rate of the fire suppression agent. The first flow rate and the second flow rate of the fire suppression agent directly or indirectly related to the angle of release of the fire suppression agent from the nozzle (e.g., larger flow rate releases at a higher angle, etc.). The fire suppression system can be configured to release the fire suppression agent from the first tank at a first time period and the fire suppression agent from the second tank at a second time period. The nozzle can also include a mechanism configured to change the angle of release.

### Fire Suppression System

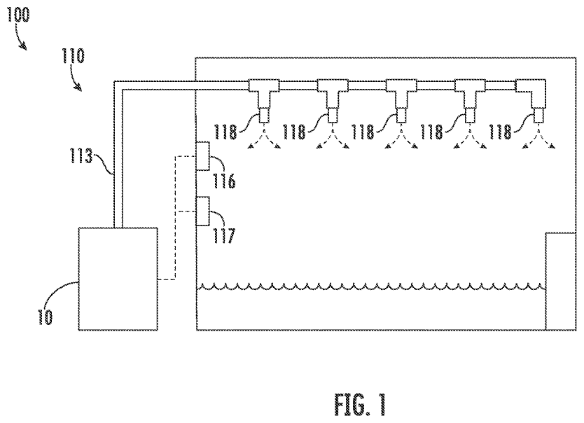

Referring to FIG. 1, a fire suppression system 100 is shown according to one embodiment. The fire suppression system 100 can be configured to suppress a fire in a stationary application (e.g., a kitchen, etc.) or in a mobile application (e.g., a truck, etc.). The fire suppression system 100 can utilize various fire suppression agents (e.g., foam, water, etc.) to suppress a fire. The fire suppression system 100 is configured to activate (e.g., release the fire suppression agent, etc.) in response to a detection of a fire. In some embodiments, the fire suppression system 100 can be configured to release the fire suppression agent stored within the fire suppression system in a single duration of time. In other embodiments, the fire suppression system 100 can be configured to release a first quantity of fire suppression agent over a first time period and release a second quantity of fire suppression agent over a second time period to limit reigniting of the fire. The fire suppression system 100 can be activated mechanically or electronically.

Fire suppression system 100 may be either a wet system or a dry system. If fire suppression system 100 is a dry system, air or another gas is present in piping or conduit system 110 downstream of activation and delivery system 10. When a pressure of the gas changes such that it is below a threshold value (e.g., due to one of nozzles 118 activating), activation and delivery system 10 activates to provide piping or conduit system 110 and nozzles 118 with the fire suppression agent. The fire suppression agent of fire suppression system 100 may be a liquid, a gas, a foam, etc. For example, the fire suppression agent may be water. In other embodiments, the fire suppression agent is a fluorine free agent.

Fire suppression system 100 includes a fire suppression tank 12 having an internal volume 14. The internal volume 14 includes a quantity of fire suppression agent. The fire suppression system 100 also includes a cartridge 20 having an internal volume 22. The internal volume 22 of the cartridge contains a quantity of expellant gas (e.g., CO₂, etc.). The cartridge 20 is coupled to an actuator 30 configured to facilitate release of the expellant gas within the internal volume 22 of the cartridge 20. The actuator 30 includes a puncture device 36 (e.g., a knife, a needle, a blade, etc.) configured to puncture a neck 24 of the cartridge 20 and allow egress of the expellant gas within the internal volume 22. The actuator 30 is coupled to the fire suppression tank 12 via tubing 34. Tubing 34 is configured to direct the expellant gas from the cartridge 20 to enter the internal volume 14 via neck 16. The expellant gas enters the internal volume 14 and forces the fire suppression agent out of the neck 16 into a pipe or conduit 113.

Referring now to FIGS. 1-9, the pipe or conduit 113 is fluidly coupled to one or more outlets or sprayers, shown as nozzles 118. The fire suppression agent flows through pipe 113 and to nozzles 118. Nozzles 118 each define one or more apertures, through which the fire suppression agent exits, forming a spray of fire suppression agent that covers a desired area. The sprays from nozzles 118 then suppress or extinguish fire within that area. The apertures of nozzles 118 can be shaped to control the spray pattern of the fire suppression agent leaving nozzles 118. Nozzles 118 can be aimed such that the sprays cover specific points of interest (e.g., a specific piece of restaurant equipment, a specific component within an engine compartment of a vehicle, etc.). Nozzles 118 can be configured such that all of nozzles 118 activate simultaneously, or nozzles 118 can be configured such that only nozzles 118 near the fire are activated.

Activation and delivery system 10 further includes an automatic activation system 50 that controls the activation of actuator 30. Automatic activation system 50 is configured to monitor one or more conditions and determine if those conditions are indicative of a nearby fire. Upon detecting a nearby fire, automatic activation system 50 activates actuator 30, causing the fire suppression agent to release through nozzles 118 and extinguish the fire.

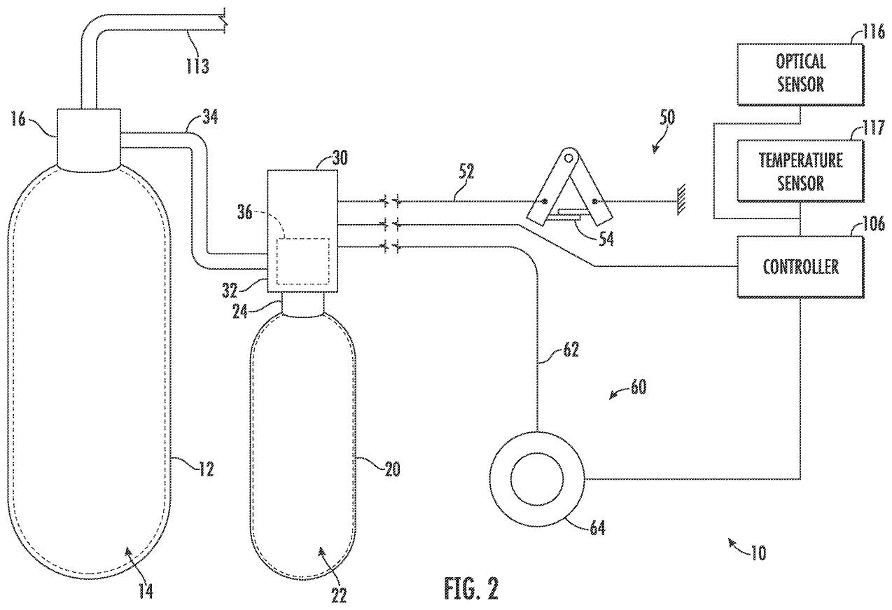

In some embodiments, actuator 30 is controlled mechanically. As shown in FIG. 2, automatic activation system 50 includes a mechanical system including a tensile member (e.g., a rope, a cable, etc.), shown as cable 52, that imparts a tensile force on actuator 30. Without this tensile force, actuator 30 will activate. Cable 52 is coupled to a fusible link 54, which is in turn coupled to a stationary object (e.g., a wall, the ground, etc.). Fusible link 54 includes two plates that are held together with a solder alloy having a predetermined melting point. A first plate is coupled to cable 52, and a second plate is coupled to the stationary object. When the ambient temperature surrounding fusible link 54 exceeds the melting point of the solder alloy, the solder melts, allowing the two plates to separate. This releases the tension on cable 52, and actuator 30 activates. In other embodiments, automatic activation system 50 is another type of mechanical system that imparts a force on actuator 30 to activate actuator 30. Automatic activation system 50 can include linkages, motors, hydraulic or pneumatic components (e.g., pumps, compressors, valves, cylinders, hoses, etc.), or other types of mechanical components configured to activate actuator 30. Some parts of automatic activation system 50 (e.g., a compressor, hoses, valves, and other pneumatic components, etc.) can be shared with other parts of fire suppression system 100 (e.g., the manual activation system 60) or vice versa.

Actuator 30 can additionally or alternatively be configured to activate in response to receiving an electrical signal from automatic activation system 50. Referring to FIG. 2, automatic activation system 50 includes a controller 106 that monitors signals from one or more sensors, shown as temperature sensor 117 and optical sensor 116 (e.g., thermocouples, resistance temperature detectors, etc.). Controller 106 can use the signals from temperature sensor 117 to determine if an ambient temperature has exceeded a threshold temperature. Upon determining that the ambient temperature has exceeded the threshold temperature, controller 106 provides an electrical signal to actuator 30. Actuator 30 then activates in response to receiving the electrical signal.

Activation and delivery system 10 further includes a manual activation system 60 that controls the activation of actuator 30. Manual activation system 60 is configured to activate actuator 30 in response to an input from an operator. Manual activation system 60 can be included instead of or in addition to the automatic activation system 50. Both automatic activation system 50 and manual activation system 60 can activate actuator 30 independently. By way of example, automatic activation system 50 can activate actuator 30 regardless of any input from manual activation system 60, and vice versa.

As shown in FIG. 2, manual activation system 60 includes a mechanical system including a tensile member (e.g., a rope, a cable, etc.), shown as cable 62, coupled to actuator 30. Cable 62 is coupled to a human interface device (e.g., a button, a lever, a switch, a knob, a pull ring, etc.), shown as button 64. Button 64 is configured to impart a tensile force on cable 62 when pressed, and this tensile force is transferred to actuator 30. Actuator 30 activates upon experiencing the tensile force. In other embodiments, manual activation system 60 is another type of mechanical system that imparts a force on actuator 30 to activate actuator 30. Manual activation system 60 can include linkages, motors, hydraulic or pneumatic components (e.g., pumps, compressors, valves, cylinders, hoses, etc.), or other types of mechanical components configured to activate the actuator 30.

Actuator 30 can additionally or alternatively be configured to activate in response to receiving an electrical signal from manual activation system 60. As shown in FIG. 2, button 64 is operably coupled to controller 106. Controller 106 can be configured to monitor the status of a human interface device (e.g., engaged, disengaged, etc.). Upon determining that the human interface device is engaged, the controller provides an electrical signal to activate actuator 30. By way of example, controller 106 can be configured to monitor a signal from button 64 to determine if button 64 is pressed. Upon detecting that button 64 has been pressed, controller 106 sends an electrical signal to actuator 30 to activate actuator 30.

Automatic activation system 50 and manual activation system 60 are shown to activate actuator 30 both mechanically (e.g., though application of a tensile force through cables, through application of a pressurized liquid, through application of a pressurized gas, etc.) and electrically (e.g., by providing an electrical signal). It should be understood, however, that automatic activation system 50 and/or manual activation system 60 can be configured to activate actuator 30 solely mechanically, solely electrically, or through some combination of both. By way of example, automatic activation system 50 can omit controller 106 and activate actuator 30 based on the input from fusible link 54. By way of another example, automatic activation system 50 can omit fusible link 54 and activate actuator 30 using an input from controller 106.

### Activation and Delivery System

Referring to FIG. 3, activation and delivery system 10 is shown according to an embodiment. Activation and delivery system 10 as shown in FIG. 3 may include any or all of the components, features, activation mechanisms, etc., as described in greater detail above with reference to FIG. 2. Activation and delivery system 10 is configured to provide fire suppression agent contained within internal volume 14A and internal volume 14B of fire suppression tank 12A and fire suppression tank 12B, respectively, to piping or conduit system 110 via pipe or conduit 113. Fire suppression tank 12A and fire suppression tank 12B are fluidly coupled to cartridge 20A and cartridge 20B, respectively. Cartridge 20A includes propellant gas within internal volume 22A. Likewise, cartridge 20B contains propellant gas within internal volume 22B. The propellant gas of cartridge 20A is pressurized at pressure p₁, while the propellant gas of cartridge 20B is pressurized at pressure p₂. Fire suppression tank 12A is fluidly coupled to valve 130 via a tube, pipe, connector, hose, etc., shown as pipe 132. Fire suppression tank 12B is similarly fluidly coupled to valve 130 via pipe 134. Valve 130 is configured to transition between various configurations to fluidly couple fire suppression tank 12A to pipe 113 when in a first configuration and to fluidly couple fire suppression tank 12B to pipe 113 when in a second configuration.

Cartridge 20A is at pressure p₁ and cartridge 20B is at pressure p₂. This results in the fire suppression agent driven out of the corresponding fire suppression tanks 12 being provided to pipe 113 at different volumetric flow rates. In some embodiments, p₁ is such that fire suppression agent which exits fire suppression tank 12A exits at a flow rate of \dot{V}₁. Likewise, p₂ may be such that fire suppression agent which exits fire suppression tank 12B exits at a flow rate of V₂. Additionally, internal volume 14A of fire suppression tank 12A may be substantially equal to the volume V_{A} of fire suppression agent provided over a first time period, and internal volume 14B of fire suppression tank 12B may be substantially equal to the volume V_{B} of fire suppression agent provided over a second time period.

Controller 106 may actuate valve 130 into the first configuration such that pipe 113 is fluidly coupled with fire suppression tank 12A. The fire suppression agent contained within internal volume 14A of fire suppression tank 12A is pressurized by the propellant gas within internal volume 22A of cartridge 20A (the propellant gas at pressure p₁) and exits fire suppression tank 12A at a flow rate of \dot{V}₁. Controller 106 maintains valve 130 in the first configuration such that the fire suppression agent from fire suppression tank 12A is provided to nozzles 118 at \dot{V}₁ until the first time period expires. When the first time period expires, controller 106 transitions valve 130 into the second configuration such that fire suppression tank 12B is fluidly coupled with pipe 113 and is configured to provide the fire suppression agent to nozzles 118 via pipe 113. Since the propellant gas of cartridge 20B is at pressure p₂ which can be less than pressure p₁, the fire suppression agent exits fire suppression tank 12B at a flow rate \dot{V}₂. In this way, controller 106 can control valve 130 such that the fire suppression agent is provided to piping system 110 at a first flow rate \dot{V}₁ for the first time period, and a second flow rate \dot{V}₂ for the second time period.

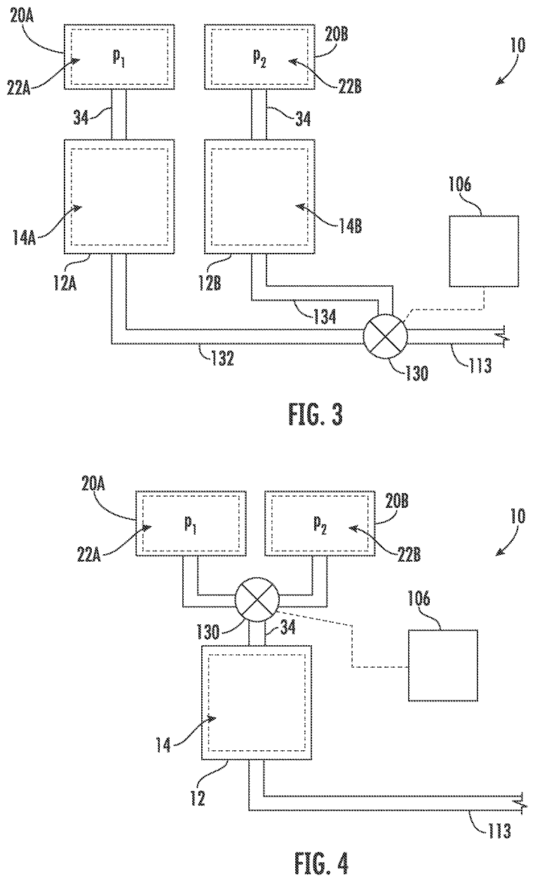

Referring now to FIG. 4, activation and delivery system 10 is shown in greater detail according to another embodiment. Activation and delivery system 10 as shown in FIG. 4 may share any of the features, configuration, components, etc., of activation and delivery system 10 as described in greater detail above with reference to FIG. 2. Additionally, activation and delivery system 10 as shown in FIG. 4 may include any of the features, configuration, components, etc., of activation and delivery system 10 as described in greater detail above with reference to FIG. 3.

Activation and delivery system 10 can include valve 130 fluidly coupled to cartridge 20A and cartridge 20B. Valve 130 is fluidly coupled to fire suppression tank 12 such that the flow of expellant gas through valve 130 drives the fire suppression agent contained within fire suppression tank 12 through pipe 113 to piping system 110. Valve 130 is fluidly coupled upstream of fire suppression tank 12 and is configured to provide expellant gas within cartridge 20A to fire suppression tank 12 when in a first configuration and to provide expellant gas within cartridge 20A to fire suppression tank 12 when in a second configuration. The expellant gas within cartridge 20A is at a pressure p₁ while the expellant gas within cartridge 20B is at a pressure p₂. The pressure p₁ of the expellant gas within cartridge 20A is such that the fire suppression agent is provided to piping system 110 at flow rate V₁ valve 130 is in the first configuration. Likewise, the pressure p₂ of the expellant gas within cartridge 20B is such that the fire suppression agent is provided to piping system 110 at a flow rate \dot{V}₂ when valve 130 is in the second configuration. In this way, transitioning valve 130 between the first and the second configuration controls the volumetric flow rate of fire suppression agent provided to piping system 110. Controller 106 is shown communicably connected with valve 130. Controller 106 is configured to transition valve 130 between the first configuration and the second configuration to control the volumetric flow rate of fire suppression agent provided to piping system 110. Controller 106 can be configured to transition valve 130 from the first configuration into the second configuration at the expiration of the first time period to achieve variable/dual flow rate of the fire suppression agent provided to piping system 110.

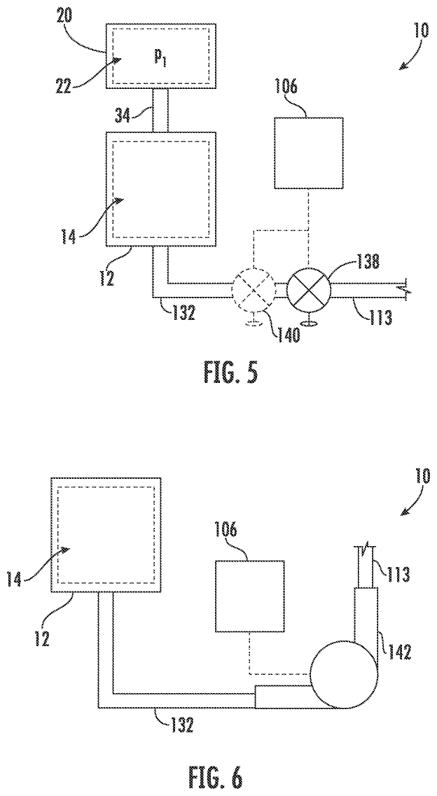

Referring now to FIG. 5, activation and delivery system 10 is shown, according to another embodiment. Activation and delivery system 10 includes cartridge 20 configured to contain expellant gas at a high pressure and fluidly couple with fire suppression tank 12. When activation and delivery system 10 is activated, the expellant gas pressurizes and drives the fire suppression agent contained within fire suppression tank 12 to piping system 110 via pipe 113. Cartridge 20 includes internal volume 22 configured to contain the expellant gas. Fire suppression tank 12 includes internal volume 14 configured to contain the fire suppression agent. Internal volume 14 of fire suppression tank 12 can be fluidly coupled with pipe 113 via pipe 132.

Activation and delivery system 10 is shown to include a regulator 138 disposed between pipe 132 and pipe 113. Regulator 138 is disposed downstream of fire suppression tank 12 and is configured to control/adjust the flow rate of fire suppression agent provided to pipe 113, according to some embodiments. In other embodiments, regulator 138 (and/or regulator 140) is disposed downstream of cartridge 20 and upstream of fire suppression tank 12 and is configured to control/adjust the flow rate of expellant gas used to mobilize the fire suppression agent within fire suppression tank 12, thereby controlling/adjusting the flow rate of fire suppression agent provided to pipe 113.

Regulator 138 may be a single state or a multi-stage regulator. In other embodiments, regulator 138 is an adjustable orifice regulator/valve/nozzle. If regulator 138 is a single stage regulator, regulator 140 (another single stage regulator) is included fluidly coupled with regulator 138 either upstream or downstream of regulator 138. Regulator 138 and/or regulator 140 can be any of pressure compensated flow regulators, temperature compensated flow regulators, etc. Regulator 138 and/or regulator 140 are configured to control/adjust the flow rate of fire suppression agent provided to pipe 113 and piping system 110. Regulator 138 and/or regulator 140 may receive control signals from controller 106. The control signals may indicate when to adjust regulator 138 and/or regulator 140 to affect the flow rate of the fire suppression agent provided to pipe 113 and piping system 110. For example, regulator 138 and/or regulator 140 can receive a control signal from controller 106 to produce volumetric flow rate \dot{V}₁. Regulator 138 and/or regulator 140 can use the control signal to adjust such that the fire suppression agent is provided to pipe 113 and piping system 110 at volumetric flow rate \dot{V}₁. Regulator 138 and/or regulator 140 may receive another control signal from controller 106 indicating that the volumetric flow rate should be reduced to \dot{V}₂. Regulator 138 and/or regulator 140 can use the control signal to adjust such that the fire suppression agent is provided to pipe 113 and piping system 110 at the volumetric flow rate \dot{V}₂. Regulator 138 and/or regulator 140 may include actuators configured to receive the control signals from controller 106 and adjust an operation of regulator 138 and/or regulator 140 to achieve the desired flow rate (e.g., \dot{V}₁ or \dot{V}₂).

Referring now to FIG. 6, activation and delivery system 10 is shown, according to another embodiment. Activation and delivery system 10 includes fire suppression tank 12 having internal volume 14 configured to contain fire suppression agent. Fire suppression tank 12 is fluidly coupled with pipe 113 (and piping system 110) via pipe 132 and pump 142. Pump 142 may be positioned upstream of fire suppression tank 12 (as a release pump) to drive the fire suppression agent through pipe 113 and piping system 110, or may be positioned downstream of fire suppression tank 12 (as a suction pump) to draw the fire suppression agent through pipe 132 and drive the fire suppression agent through pipe 113 to piping system 110. Pump 142 may be a variable speed pump such that pump 142 is configured to provide the fire suppression agent to piping system 110 at a variable or adjustable flow rate. Controller 106 is configured to provide control signals to pump 142 to adjust the flow rate of the fire suppression agent provided to piping system 110. Controller 106 may provide a first set of control signals that cause pump 142 to operate such that the fire suppression agent is provided to piping system 110 at a first flow rate (e.g., \dot{V}₁) and later provide a second set of control signals that cause pump 142 to operate such that the fire suppression agent is provided to piping system 110 at a second flow rate (e.g., \dot{V}₂).

### Nozzles

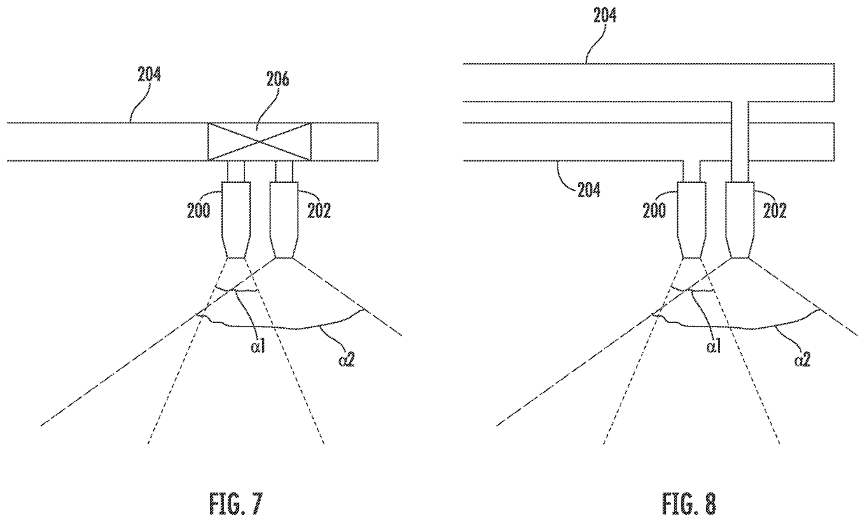

Referring to FIGS. 7-9, nozzles 118 are shown according to various embodiments. Nozzles 118 have a conical spray pattern when the fire suppression agent is released. Nozzles 118 can have other spray patterns (e.g., square, rectangle, line, ellipse, etc.). The conical spray pattern has an angle of spray, which can be directly or indirectly related to the flow rate and/or pressure of the fire suppression agent as the fire suppression agent is released from nozzle 118. Larger pressures and flow rates generate a narrower conical spray pattern (e.g., smaller angle of spray, etc.), and smaller pressures and flow rates generate a larger conical spray pattern (e.g., larger angle of spray, etc.). Altering the flow rate and/or pressure of the fire suppression agent as the fire suppression agent is released from nozzle 118 can alter the angle of spray of the fire suppression agent released from nozzle 118 during activation. Nozzles 118 may be configured to change an angle of spray of the fire suppression agent from a first angle (e.g., α₁, etc.) to a second angle (e.g., α₂, etc.) in addition to the changing flow rate as described above in FIGS. 3-6, or as a stand-alone system. By way of example, \dot{V}₁ is directly related to α₁, and \dot{V}₂ is directly related to α₂. As will be described below, various methods of altering the angle of spray of fire suppression agent during activation of the fire suppression system can be utilized. The methods can include any characteristic or component of the above described activation and delivery systems 10 as shown in FIGS. 3-6.

In one embodiment, nozzles 118 are grouped into pairs of nozzles 118, each having predetermined flow characteristics (e.g., wide spray, narrow spray, etc.). The pair of nozzles 118 can be positioned a predetermined distance away from the specific point of interest to maximize suppression of a fire. By way of example, the pair of nozzles 118 is positioned 6-48 inches away from the specific point of interest, and specifically at 8 inches away from the specific point of interest. A first nozzle 200 of the pair of nozzles 118 is positioned in close proximity (e.g., within 2 inches, etc.) to a second nozzle 202 of the pair of nozzles 118. The first nozzle 200 is configured to release the fire suppression agent in a conical pattern. The conical pattern has a first angle of spray α₁ defined by an angle between a first edge of the conical spray pattern and a second edge of the conical spray pattern. The first edge and the second edge being opposite each other. The second nozzle 202 is configured to release the fire suppression agent in a conical pattern. The conical pattern has a second angle of spray α₂ defined similar to the first angle of spray. In some embodiments, α₁ is larger or smaller than α₂. In other embodiments, α₁ and α₂ are equal. A smaller α₁ can facilitate suppression of flames of a fire within the specific point of interest, cooling of the specific point of interest, and formation of a crust covering a heated surface of the specific point of interest. A larger α₂ can facilitate continued cooling of the specific point of interest, and can maintain the crust covering the heated surface of the specific point of interest to minimize occurrences of the fire reigniting. An example angle for α₁ of the first nozzle 200 is 45 and for α₂ of the second nozzle 202 is 120°. In some embodiments α₁ may be 45°±10° and α₂ may be 120°±10°.

The first nozzle 200 and the second nozzle 202 can be incorporated in the fire suppression system 100 as shown in FIGS. 7 and 8. In one embodiment, the first nozzle 200 and the second nozzle 202 can be coupled in line (e.g., in succession to each other, etc.) to a pipe 204 (e.g., pipe 113, etc.) of the piping system 110. The pipe 204 is configured to supply fire suppression agent from the fire suppression tank 12 to at least one of the first nozzle 200 and the second nozzle 202. The fire suppression system 100 can include a flow restrictor 206 (e.g., a damper, a blockage, a valve, etc.) within the pipe 204, the first nozzle 200, and/or the second nozzle 202. The flow restrictor 206 can be configured to limit (e.g., restrict, etc.) the flow of the fire suppression agent from reaching at least one of the first nozzle 200 and the second nozzle 202. The flow restrictor 206 can be actuated in response to a signal from a controller (e.g., controller 106, etc.) or expiration of a time period.

The controller can be remote of the fire suppression system 100 and/or communicate wirelessly (e.g., Wi-Fi, Bluetooth, LAN, etc.) to the flow restrictor 206. The controller can also communicate via a wired connection to the flow restrictor 206. The controller can be configured to receive a signal to actuate the flow restrictor 206 from a user, controller 106, the temperature sensor 117, the optical sensor 116, and/or the manual activation system 60. The signal received by the controller may include at least one of actuating the flow restrictor 206 to limit flow of fire suppression agent to the first nozzle 200, limit flow of fire suppression agent to the second nozzle 202, and limit flow of fire suppression agent to the first nozzle 200 and the second nozzle 202.

The controller may be provided with a method of operating the flow restrictor 206 by a user prior to activation of the fire suppression system 100. The method of operating can be triggered (e.g., activated, etc.) in response to a condition within the fire suppression system 100. The condition can include at least one of the temperature sensor 117 and/or the optical sensor 116 detecting a fire, the actuator 30 puncturing the cartridge 20, the flow of fire suppression from the fire suppression tank 12, the activation of the manual activation system 60, activation of valve 130, a change of speed of pump 142, an adjustment of regulator 138, and a signal from a user. The method may include at least one of actuate the flow restrictor 206 to a first position to facilitate flow of fire suppression agent to the first nozzle 200 for a first time period, actuate the flow restrictor 206 to a second position to facilitate flow of the fire suppression agent to the second nozzle 202 for a second time period. The first time period and the second time period can be different or the same time period. The first time period can be 1-10 seconds, preferably 7 seconds. The flow restrictor 206 in the first position supplies flow of the fire suppression agent to the first nozzle 200 for the first time period to release the fire suppression agent at cu. The flow restrictor 206 in the second position supplies flow of the fires suppression agent to the second nozzle 202 for the second time period to release the fire suppression agent at α₂.

The first nozzle 200 and the second nozzle 202 can also be coupled to separate pipes 204 (e.g., pipe 204, pipe 132, pipe 134, etc.). The pipes 204 can each be coupled to separate fire suppression tanks 12 (e.g., fire suppression tank 12A, fire suppression tank 12B, etc.) to facilitate isolated flow of fire suppression agent to each of the first nozzle 200 and the second nozzle 202. The isolated flows can have the same or different flow properties (e.g., pressure, flow rate, etc.) and/or fluid properties (e.g., fire suppression agents type, material, etc.). The pipes 204 can also be coupled to the same fire suppression tank 12 and include the flow restrictor 206 at a location where the pipes 204 are fluidly connected. The flow restrictor 206 can function as described above.

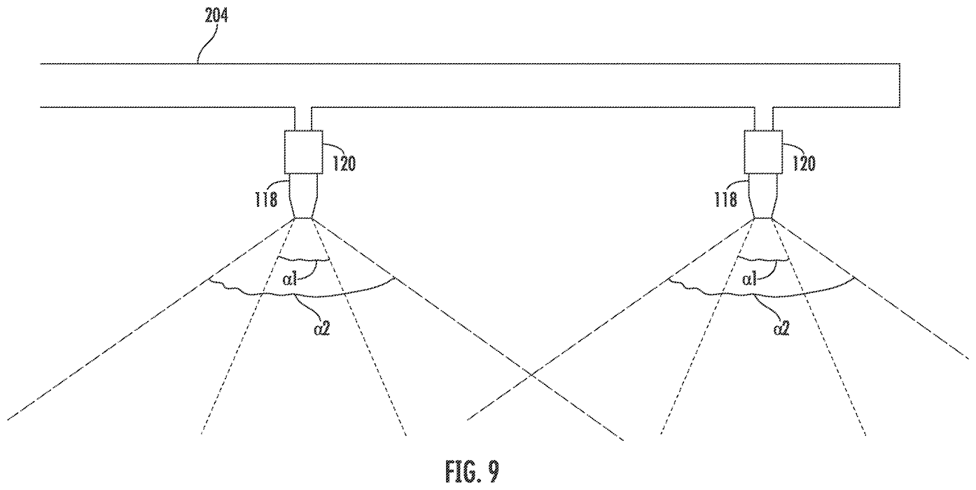

Referring to FIG. 9, nozzle 118 is shown according to another embodiment. Nozzle 118 is configured to release the fire suppression agent in a conical spray pattern. The conical spray pattern has a first angle of spray, defined as described above. The conical spray pattern is formed by a specific structure of nozzle 118. Nozzle 118 can include various components spaced and positioned relative to each other to release the fire suppression agent in the conical spray pattern. Nozzle 118 can also include a mechanism 120 positioned internal or external of nozzle 118 and configured to alter the spacing and/or positioning of components of nozzle 118. The altering of the spacing and/or positioning of components of nozzle 118 may change the angle of the conical spray pattern from α₁ to α₂.

In one embodiment, the mechanism 120 may be a spring within nozzle 118 configured to move internal components of nozzle 118 (e.g., a plate, valve, or deflector) from a first position to a second position to release the fire suppression agent at α₁ for the first time period and at as for the second time period. The spring may be preloaded and configured to activate (e.g., release, etc.) in response to a signal (e.g., pneumatic, electronic, etc.) from the controller.

In other embodiments, the mechanism 120 may be a variable orifice in the nozzle 118 configured to affect the release flow rate and thus the angle of spray of the fire suppression agent. In some embodiments, the orifice adjusts automatically after a predetermined amount of time. In other embodiments, the mechanism 120 includes an actuator configured to receive control signals from the controller and adjust the orifice of the nozzle 118 such that the release flow rate and the angle of spray of the fire suppression agent is adjusted (e.g., from α₁ to α₂). A solenoid valve may be configured to adjust the variable orifice. The solenoid valve can receive a signal from the controller and adjust the orifice accordingly. The mechanism 120 may also be an outer housing included on nozzle 118 that can rotate with respect to an inner housing to adjust the variable orifice. The outer housing may be rotated manually or automatically. The mechanism 120 may also be an actuator coupled to the outer housing and configured to rotate the outer housing in response to a signal from the controller. The actuator may be configured to exert a torque on the outer housing which in turn rotates the outer housing and adjusts the variable orifice.

Each of the embodiments shown in FIGS. 3-9 may be used as stand-alone methods to change the angle of spray of the fire suppression agent released from nozzle 118 from α₁ to α₂. Each of the embodiments may be used in combination with any other embodiment to change the angle of spray of the fire suppression agent released from nozzle 118 from α₁ to α₂.

### Test Results

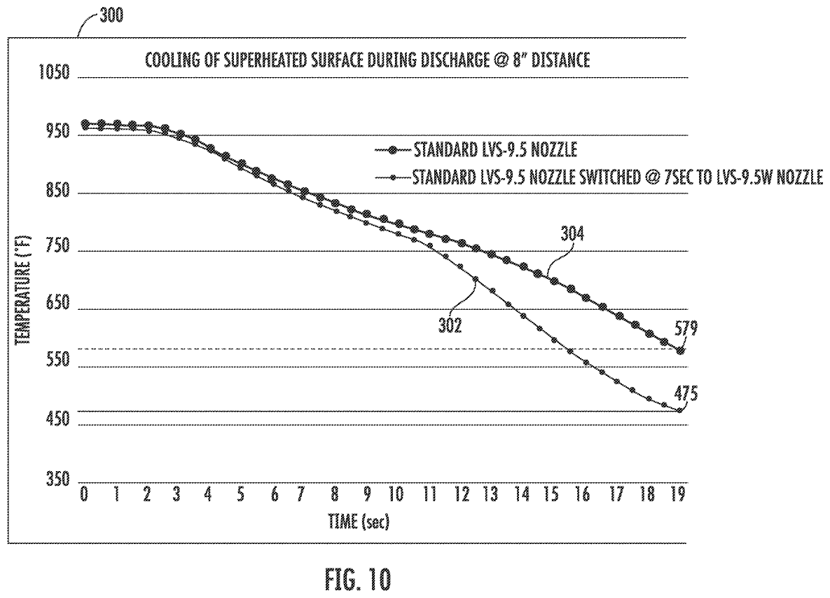

Referring to FIG. 10, a table 300 is shown according to an exemplary embodiment. Table 300 illustrates results of a test to demonstrate the cooling ability of changing the angle of spray of the fire suppression during activation of the fire suppression system 100 when compared to a standard single angle nozzle having fire suppression released through the nozzle during activation. As shown in table 300, line 302 represents the changing angle nozzle 118 of the present disclosure and line 304 represents a standard single angle nozzle. The cooling capability of the changing angle nozzle 118 is shown to be greater than the cooling capability of the standard single angle nozzle during activation. The changing angle nozzle 118 changed from α₁ to α₂ 7 seconds into activation. The changing angle nozzle 118 and the standard single angle nozzle were activated at a distance of 8 inches from the hazard area when the hazard area was at 960° F. The changing angle nozzle 118 cooled the hazard area to a temperature of 475° F. and the standard single angle nozzle cooled the hazard area to a temperature of 579° F. The slope of line 302 is greater than the slope of line 304 after changing from α₁ to α₂.

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

Additionally, any element disclosed in one embodiment may be incorporated or utilized with any other embodiment disclosed herein. For example, the delivery system 10 described in at least paragraph [0022]-[0031] and FIG. 3-6 and, may be incorporated in nozzle 118 described in at least paragraphs [0032]-[0042] and FIGS. 6-10. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A fire suppression system, comprising:
an agent tank configured to store a quantity of a fire suppression agent;
a nozzle configured to release at least a portion of the quantity of the fire suppression agent;
a conduit coupling the agent tank to the nozzle to direct the fire suppression agent from the agent tank to the nozzle;
wherein the fire suppression agent is released through the nozzle in a conical pattern having a spray angle defined between two edges of the conical pattern;
wherein the spray angle is a first spray angle for a first time period and a second spray angle for a second time period.

2. The fire suppression system of claim 1, wherein the nozzle is a distance of 6-48 inches from a hazard area.

3. The fire suppression system of claim 1, wherein the nozzle comprises a pair of nozzles.

4. The fire suppression system of claim 3, wherein a first nozzle of the pair of nozzles is configured to release the fire suppression agent at the first spray angle and for the first time period, and a second nozzle of the pair of nozzles is configured to release the fire suppression agent at the second spray angle and for the second time period.

5. The fire suppression system of claim 1, wherein the first spray angle is approximately 45 degrees.

6. The fire suppression system of claim 1, wherein the second spray angle is approximately 120 degrees.

7. The fire suppression system of claim 1, wherein the first time period is approximately 7 seconds.

8. The fire suppression system of claim 1, wherein the nozzle comprises a mechanism configured to change the spray angle of the fire suppression agent from the first spray angle to the second spray angle during activation of the fire suppression system.

9. The fire suppression system of claim 1, further comprising a valve located within the conduit and configured to change a pressure of the fire suppression agent within the conduit.

10. The fire suppression system of claim 9, wherein the change in the pressure of the fire suppression agent within the fire suppression system facilitates change of a release angle of fire suppression agent from the first spray angle to the second spray angle.

11. A fire suppression nozzle for releasing a fire suppression agent, comprising:
a first nozzle configured to release the fire suppression agent at a first spray angle for a first time period; and
a second nozzle configured to release the fire suppression agent at a second spray angle for a second time period.

12. The fire suppression nozzle of claim 11, wherein the first spray angle is approximately 45 degrees.

13. The fire suppression nozzle of claim 11, wherein the second spray angle is approximately 120 degrees.

14. The fire suppression nozzle of claim 11, wherein the first time period is approximately 7 seconds.

15. The fire suppression nozzle of claim 11, wherein the first spray angle is approximately 45 degrees and the second spray angle is approximately 120 degrees.

16. The fire suppression nozzle of claim 11, further comprising a mechanism, the mechanism configured to change spray of the fire suppression agent from the first nozzle at the first spray angle to the second nozzle at the second spray angle.

17. A method for suppressing a fire, comprising:
providing a fire suppression system including at least one nozzle within a hazard area;
activating the fire suppression system in response to detecting a potential fire within the hazard area;
releasing a fire suppression agent toward the hazard area through the at least one nozzle at a spray angle defined by an angle between outermost edges of the fire suppression agent when released through the at least one nozzle, wherein the spray angle is a first spray angle for a first time period; and
releasing the fire suppression agent toward the hazard area through the at least one nozzle at a second spray angle, greater than the first spray angle, for a second time period.

18. The method of claim 17, wherein the at least one nozzle is a distance of 6-48 inches from the hazard area.

19. The method of claim 17, wherein the at least one nozzle comprises a pair of nozzles.

20. The method of claim 19, wherein a first nozzle of the pair of nozzles is configured to release the fire suppression agent at the first spray angle and for the first time period, and a second nozzle of the pair of nozzles is configured to release the fire suppression agent at the second spray angle and for the second time period.

21. The method of claim 17, wherein the first spray angle is approximately 45 degrees.

22. The method of claim 17, wherein the second spray angle is approximately 120 degrees.

23. The method of claim 17, wherein the first time period is approximately 7 seconds.

24. The method of claim 17, wherein the at least one nozzle comprises a mechanism configured to change the spray angle of the fire suppression agent from the first spray angle to the second spray angle during activation of the fire suppression system.

25. The method of claim 17, wherein the fire suppression system includes a valve configured to change a pressure of the fire suppression agent within the fire suppression system.

26. The method of claim 25, wherein the change in the pressure of the fire suppression agent within the fire suppression system causes the change of the spray angle of the fire suppression agent from the first spray angle to the second spray angle.
